(19) United States
(12) Patent Application Publication
(10) Pub. No.: US 2008/0298643 A1
(43) Pub. Date: Dec. 4, 2008

(54) COMPOSITE PERSON MODEL FROM IMAGE COLLECTION

(76) Inventors: Joel S. Lawther, Pittsford, NY (US); Peter O. Stubler, Rochester, NY (US); Madirakshi Das, Rochester, NY (US); Alexander C. Loui, Penfield, NY (US); Dale F. McIntyre, Honeoye Falls, NY (US)

Correspondence Address: Frank Pincelli;Patent Legal Staff, Eastman Kodak Company, 343 State Street, Rochester, NY, 14650-2201, US

(21) Appl. No.: 11/755,343

(22) Filed: May 30, 2007

(51) Int. Cl. G06K 9/00

(52) U.S. Cl. 382/118

(57) ABSTRACT

A method of improving recognition of a particular person in images by constructing a composite model of at least the portion of the head of that particular person, includes acquiring a collection of images taken during a particular event; identifying image(s) having a particular person in the collection; identifying one or more features in the identified image(s) associated with that particular person; searching the collection using the identified features to identify the particular person in other images of the collection; and constructing a composite model of at least a portion of the particular person's head using identified images of the particular person.

### CROSS-REFERENCE TO RELATED APPLICATION

Reference is made to commonly assigned U.S. patent application Ser. No. 11/263,156, filed Oct. 3, 2005, entitled “Determining a Particular Person From a Collection” by Andrew C. Gallagher et al., the disclosure of which is incorporated herein by reference.

### FIELD OF THE INVENTION

The present invention relates to the production of a composite model of a person from an image collection and the use of this composite model.

### BACKGROUND OF THE INVENTION

With the advent of digital photography, consumers are amassing large collections of digital images and videos. The average number of images captures with digital cameras per photographer is still increasing each year. As a consequence, the organization and retrieval of images and videos is already a problem for the typical consumer. Currently, the length of time spanned by a typical consumer's digital image collection is only a few years. The organization and retrieval problem will continue to grow as the length of time spanned by the average digital image and video collection increases.

A user often desires to find images and videos containing a particular person of interest. The user can perform a manual search to find images and videos containing the person of interest. However this is a slow, laborious process. Even though some commercial software (e.g. Adobe Album) allows users to tag images with labels indicating the people in the images so that searches can later be done, the initial labeling process is still very tedious and time consuming.

Face recognition software assumes the existence of a ground-truth labeled set of images (i.e. a set of images with corresponding person identities). Most consumer image collections do not have a similar set of ground truth. In addition, the labeling of faces in images is complex because many consumer images have multiple persons. So simply labeling an image with the identities of the people in the image does not indicate which person in the image is associated with which identity.

There exists many image processing packages that attempt to recognize people for security or other purposes. Some examples are the FaceVACS face recognition software product from Cognitec Systems GmbH and the Facial Recognition SDKs product from Imagis Technologies Inc. and Identix Inc. These software packages are primarily intended for security-type applications where the person faces the camera under uniform illumination, frontal pose and neutral expression. These methods are not suited for use in personal consumer images due to the large variations in pose, illumination, expression and face size encountered in images in this domain.

In addition, such programs do not produce the library necessary to perform an effective identification of people over time. As people age, their faces change and they have several pairs of glasses, multiple types of clothing, and various hairstyles over time. Furthermore, there is an unmet need for the retention of unique features associated with a person to provide clues to recognize, identify search and manage image collections for a person over time.

### SUMMARY OF THE INVENTION

It is an object of the present invention to readily identify persons of interests and the features that can help identify them in images or videos in a digital image collection. This object is achieved by a method of improving recognition of a particular person in images by constructing a composite model of at least the portion of the head of that particular person comprising:

(a) acquiring a collection of images taken during a particular event;

(b) identifying image(s) having a particular person in the collection;

(c) identifying one or more features in the identified image(s) associated with that particular person;

(d) searching the collection using the identified features to identify the particular person in other images of the collection; and

(e) constructing a composite model of at least a portion of the particular person's head using identified images of the particular person.

This method has the advantage of producing a composite model of a person from a given image collection that can be used to search other image collections. It also enables the retention of composite and feature models to enable recognition of a person when the person is not looking at the camera or the head is obscured from the view of the camera.

### BRIEF DESCRIPTION OF THE DRAWINGS

The subject matter of the invention is described with reference to the embodiments shown in the drawings.

FIG. 1 is a block diagram of a camera phone based imaging system that can implement the present invention;

FIG. 2 is a block diagram of an embodiment of the present invention for composite and extracted image segments for person identification;

FIG. 3 is a flow chart of an embodiment of the present invention for the creation of a composite model of a person in a digital image collection;

FIG. 4 is a representation of a set of person profiles associated with event images;

FIG. 5 is a collection of image acquired from an event;

FIG. 6 is a representation of face points and facial features of a person;

FIG. 7 is a representation of organization of images at an event by people and features;

FIG. 8 is an intermediate representation of event data;

FIG. 9 is a resolved representation of an event data set;

FIG. 10 is a visual representation of the resolved event data set;

FIG. 11 is an updated representation of person profiles associated with event images;

FIG. 12 is a flow chart for construction of composite image files

FIG. 13 is a flow chart for the identification of a particular person in a photograph; and

FIG. 14 is a flow chart for the searching of a particular person in a digital image collection.

### DETAILED DESCRIPTION OF THE INVENTION

In the following description, some embodiments of the present invention will be described as software programs. Those skilled in the art will readily recognize that the equivalent of such a method can also be constructed as hardware or software within the scope of the invention.

Because image manipulation algorithms and systems are well known, the present description will be directed in particular to algorithms and systems forming part of, or cooperating more directly with, the method in accordance with the present invention. Other aspects of such algorithms and systems, and hardware or software for producing and otherwise processing the image signals involved therewith, not specifically shown or described herein can be selected from such systems, algorithms, components, and elements known in the art. Given the description as set forth in the following specification, all software implementation thereof is conventional and within the ordinary skill in such arts.

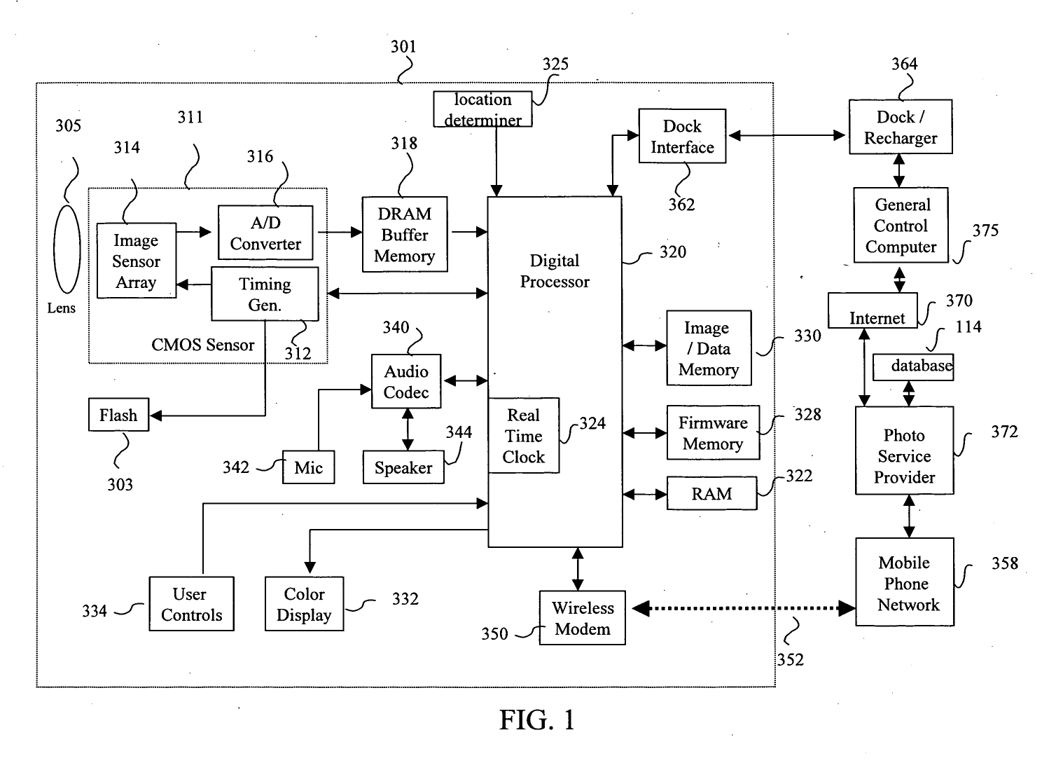

FIG. 1 is a block diagram of a digital camera phone 301 based imaging system that can implement the present invention. The digital camera phone 301 is one type of digital camera. Preferably, the digital camera phone 301 is a portable battery operated device, small enough to be easily handheld by a user when capturing and reviewing images. The digital camera phone 301 produces digital images that are stored using the image data/memory 330, which can be, for example, internal Flash EPROM memory, or a removable memory card. Other types of digital image storage media, such as magnetic hard drives, magnetic tape, or optical disks, can alternatively be used to provide the image/data memory 330.

The digital camera phone 301 includes a lens 305 that focuses light from a scene (not shown) onto an image sensor array 314 of a CMOS image sensor 311. The image sensor array 314 can provide color image information using the well-known Bayer color filter pattern. The image sensor array 314 is controlled by timing generator 312, which also controls a flash 303 in order to illuminate the scene when the ambient illumination is low. The image sensor array 314 can have, for example, 1280 columns×960 rows of pixels.

In some embodiments, the digital camera phone 301 can also store video clips, by summing multiple pixels of the image sensor array 314 together (e.g. summing pixels of the same color within each 4 column×4 row area of the image sensor array 314) to produce a lower resolution video image frame. The video image frames are read from the image sensor array 314 at regular intervals, for example using a 24 frame per second readout rate.

The analog output signals from the image sensor array 314 are amplified and converted to digital data by the analog-to-digital (A/D) converter circuit 316 on the CMOS image sensor 311. The digital data is stored in a DRAM buffer memory 318 and subsequently processed by a digital processor 320 controlled by the firmware stored in firmware memory 328, which can be flash EPROM memory. The digital processor 320 includes a real-time clock 324, which keeps the date and time even when the digital camera phone 301 and digital processor 320 are in their low power state.

The processed digital image files are stored in the image/data memory 330. The image/data memory 330 can also be used to store the personal profile information 236, in database 114. The image/data memory 330 can also store other types of data, such as phone numbers, to-do lists, and the like.

In the still image mode, the digital processor 320 performs color interpolation followed by color and tone correction, in order to produce rendered sRGB image data. The digital processor 320 can also provide various image sizes selected by the user. The rendered sRGB image data is then JPEG compressed and stored as a JPEG image file in the image/data memory 330. The JPEG file uses the so-called “Exif” image format described earlier. This format includes an Exif application segment that stores particular image metadata using various TIFF tags. Separate TIFF tags can be used, for example, to store the date and time the picture was captured, the lens f/number and other camera settings, and to store image captions. In particular, the Image Description tag can be used to store labels. The real-time clock 324 provides a capture date/time value, which is stored as date/time metadata in each Exif image file.

A location determiner 325 provides the geographic location associated with an image capture. The location is preferably stored in units of latitude and longitude. Note that the location determiner 325 can determine the geographic location at a time slightly different than the image capture time. In that case, the location determiner 325 can use a geographic location from the nearest time as the geographic location associated with the image. Alternatively, the location determiner 325 can interpolate between multiple geographic positions at times before and/or after the image capture time to determine the geographic location associated with the image capture. Interpolation can be necessitated because it is not always possible for the location determiner 325 to determine a geographic location. For example, the GPS receivers often fail to detect signal when indoors. In that case, the last successful geographic location reading (i.e. prior to entering the building) can be used by the location determiner 325 to estimate the geographic location associated with a particular image capture. The location determiner 325 can use any of a number of methods for determining the location of the image. For example, the geographic location can be determined by receiving communications from the well-known Global Positioning Satellites (GPS).

The digital processor 320 also produces a low-resolution “thumbnail” size image, which can be produced as described in commonly-assigned U.S. Pat. No. 5,164,831 to Kuchta, et al., the disclosure of which is incorporated by reference herein. The thumbnail image can be stored in RAM memory 322 and supplied to a color display 332, which can be, for example, an active matrix LCD or organic light emitting diode (OLED). After images are captured, they can be quickly reviewed on the color LCD image display 332 by using the thumbnail image data.

The graphical user interface displayed on the color display 332 is controlled by user controls 334. The user controls 334 can include dedicated push buttons (e.g. a telephone keypad) to dial a phone number, a control to set the mode (e.g. “phone” mode, “camera” mode), a joystick controller that includes 4-way control (up, down, left, right) and a push-button center “OK” switch, or the like.

An audio codec 340 connected to the digital processor 320 receives an audio signal from a microphone 342 and provides an audio signal to a speaker 344. These components can be used both for telephone conversations and to record and playback an audio track, along with a video sequence or still image. The speaker 344 can also be used to inform the user of an incoming phone call. This can be done using a standard ring tone stored in firmware memory 328, or by using a custom ring-tone downloaded from a mobile phone network 358 and stored in the image/data memory 330. In addition, a vibration device (not shown) can be used to provide a silent (e.g. non audible) notification of an incoming phone call.

A dock interface 362 can be used to connect the digital camera phone 301 to a dock/charger 364, which is connected to a general control computer 375. The dock interface 362 can conform to, for example, the well-know USB interface specification. Alternatively, the interface between the digital camera 301 and the general control computer 375 can be a wireless interface, such as the well-known Bluetooth wireless interface or the well-know 802.11b wireless interface. The dock interface 362 can be used to download images from the image/data memory 330 to the general control computer 375. The dock interface 362 can also be used to transfer calendar information from the general control computer 375 to the image/data memory in the digital camera phone 301. The dock/charger 364 can also be used to recharge the batteries (not shown) in the digital camera phone 301.

The digital processor 320 is coupled to a wireless modem 350, which enables the digital camera phone 301 to transmit and receive information via an RF channel 352. A wireless modem 350 communicates over a radio frequency (e.g. wireless) link with the mobile phone network 358, such as a 3GSM network. The mobile phone network 358 communicates with a photo service provider 372, which can store digital images uploaded from the digital camera phone 301. These images can be accessed via the Internet 370 by other devices, including the general control computer 375. The mobile phone network 358 also connects to a standard telephone network (not shown) in order to provide normal telephone service.

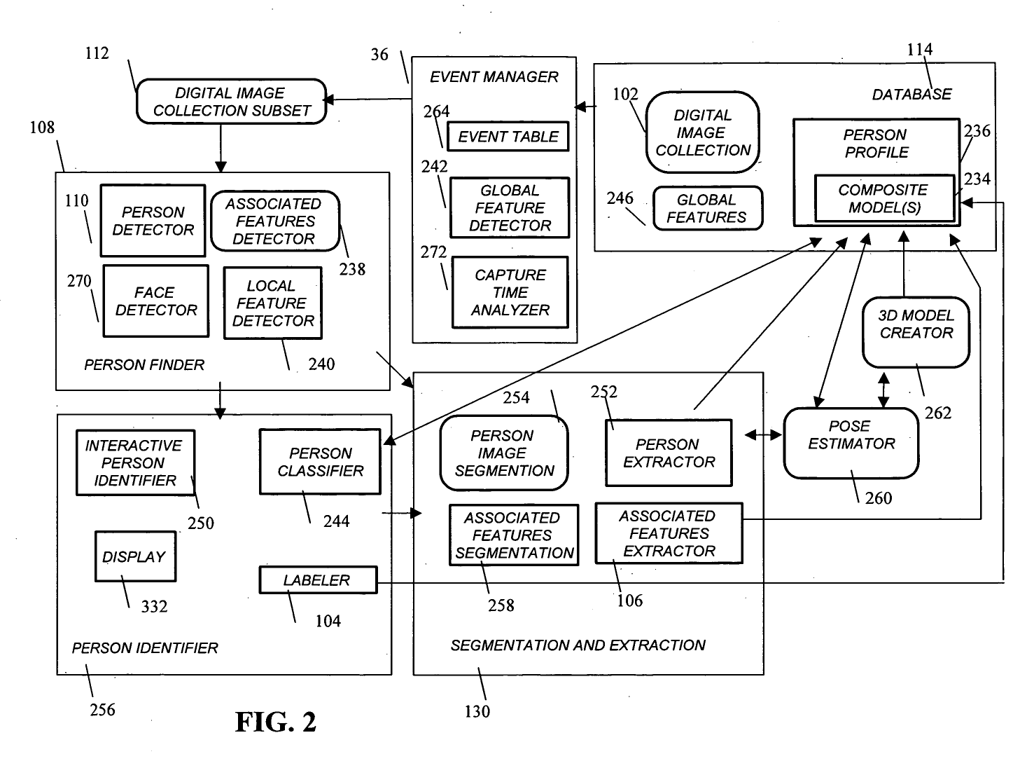

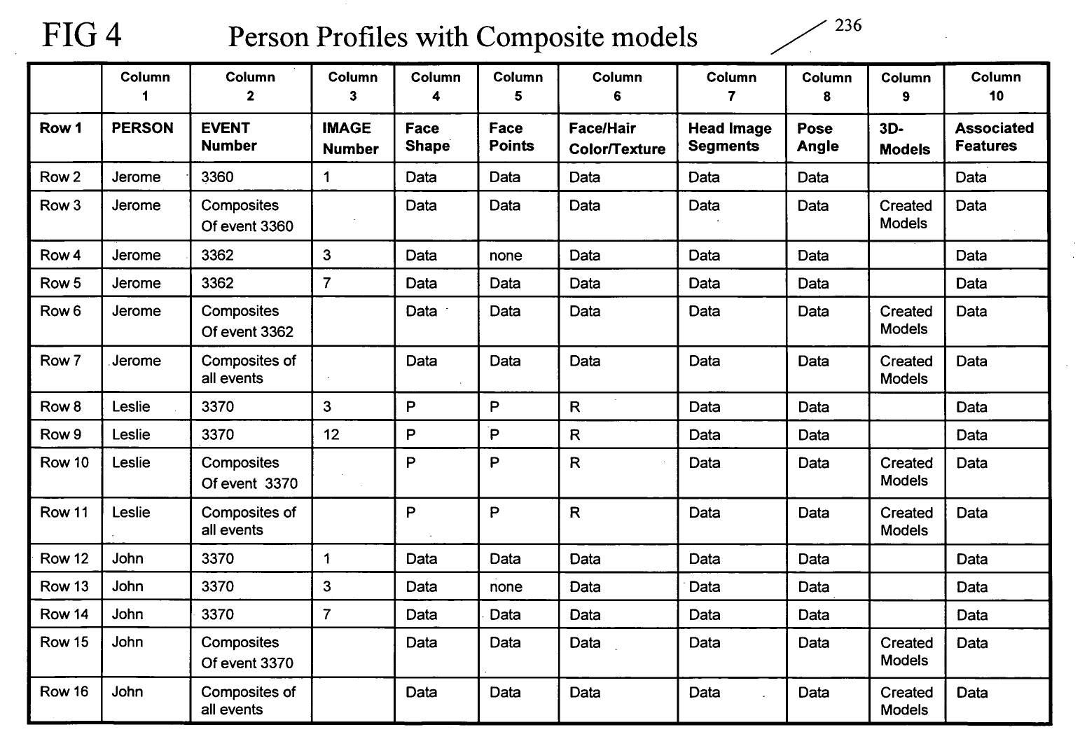

A block diagram of an embodiment of the invention is illustrated in FIG. 2. With brief reference back to FIG. 1., the image/data memory 330, firmware memory 328, RAM 332 and digital processor 330 can be used to provide the necessary data storage functions as described below. Briefly, the diagram contains a database 114 containing a digital image collection 102. Information about the images such as metadata about the images as well as the camera are disclosed as global features 246. Person profile 236 includes information about individuals within the collection. Such person profiles can contain relational databases about distinguishing characteristics of a person. The concept of relational databases is described by Edgar Frank Codd in “A Relational Model of Data for Large Shared Data Banks,” published in Communications of the ACM (Vol. 13, No. 6, June 1970, pp. 377-87). Additional personal relational database construction methods are described in commonly-assigned U.S. Pat. No. 5,652,880 to Seagraves, the disclosure of which is herein incorporated by reference. A person profile example is shown in FIG. 4.

An event manager 36 enables improvement of image management and organization by clustering digital image subsets into relevant time periods using capture time analyzer 272. A global feature detector 242 interprets global features 246 from database 114. Event manager 36 thereby produces digital image collection subset 112. A person finder 108 uses person detector 110 to find persons within the photograph. A face detector 270 finds faces or parts of faces using a local feature detector 240. Associated features with a person can be identified using an associated features detector 238. Person identification is the assignment of a person's name to a particular person of interest in the collection. This is achieved via an interactive person identifier 250 associated with display 332 and a labeler 104. Furthermore, a person classifier 244, can be employed for applying name labels to persons previously identified in the collection. A Segmentation and Extraction 130 is for person image segmentation 254 using person extractor 252. An associated features segmentation 258 and associated features extractor enables the segmenting and extraction of associated person elements for recording as a composite model 234 in the in the person profile 236. A pose estimator 260, provides a three-dimensional (3D) model creator 262 with detail for the creation of a surface or solid representation model of at least head elements of the person using 3D model creator 262.

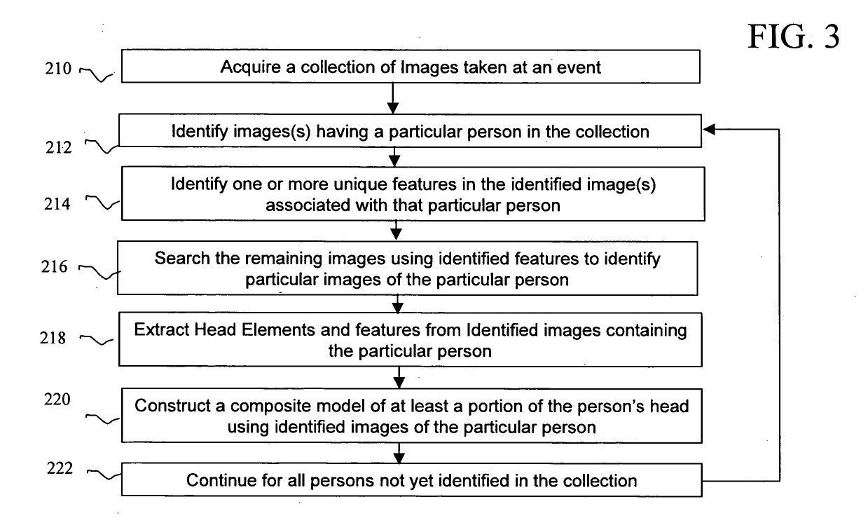

FIG. 3 is a flow diagram showing a method of improving recognition of a particular person in images by constructing a composite model of at least the portion of the head of that particular person. Those skilled in the art will recognize that the processing platform for using the present invention can be a camera, a personal computer, a remote computer assessed over a network such as the Internet, a printer, or the like.

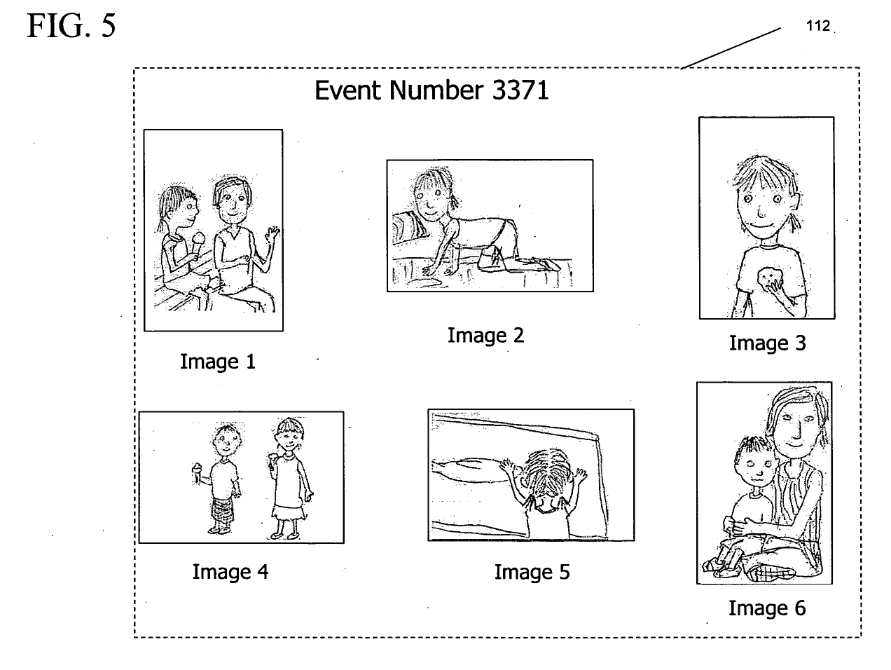

Step 210 is acquiring a collection of images taken at an event. Events can be a birthday party, vacation, collection of family moments or a soccer game. Such events can also be broken into sub-events. A birthday party can comprise cake, presents, and outdoor activities. A vacation can be a series of sub-events associated with various cities, times of the day, visits to the beach etc. An example of a cluster of images identified as an event is shown in FIG. 5. Events can be tagged manually or can be clustered automatically. Commonly assigned U.S. Pat. Nos. 6,606,411 and 6,351,556, disclose algorithms for clustering image content by temporal events and sub-events. The disclosures of the above patents are herein incorporated by reference. U.S. Pat. No. 6,606,411 teaches that events have consistent color distributions, and therefore, these pictures are likely to have been taken with the same backdrop. For each sub-event, a single color and texture representation is computed for all background areas taken together. The above patents teach how to cluster images and videos in a digital image collection into temporal events and sub-events. The terms “event” and “sub-event” are used in an objective sense to indicate the products of a computer mediated procedure that attempts to match a user's subjective perceptions of specific occurrences (corresponding to events) and divisions of those occurrences (corresponding to sub-events). A collection of images are classified into one or more events determining one or more largest time differences of the collection of images based on time or date clustering of the images and separating the plurality of images into the events based on having one or more boundaries between events which one or more boundaries correspond to the one or more largest time differences. For each event, sub-events (if any) can be determined by comparing the color histogram information of successive images as described in U.S. Pat. No. 6,351,556. Dividing an image into a number of blocks and then computing the color histogram for each of the blocks accomplish this. A block-based histogram correlation procedure is used as described in U.S. Pat. No. 6,351,556 to detect sub-event boundaries. Another method of automatically organizing images into events is disclosed in commonly assigned U.S. Pat. No. 6,915,011, which is herein incorporated by reference. In accordance with the present invention, an event clustering method uses foreground and background segmentation for clustering images from a group into similar events. Initially, each image is divided into a plurality of blocks, thereby providing block-based images. Using a block-by-block comparison, each block-based image is segmented into a plurality of regions comprising at least a foreground and a background. One or more luminosity, color, position or size features are extracted from the regions and the extracted features are utilized to estimate and compare the similarity of the regions comprising the foreground and background in successive images in the group. Then, a measure of the total similarity between successive images is computed, thereby providing image distance between successive images, and event clusters are delimited from the image distances.

A further benefit of the clustering of images into events is that within an event or sub-event, there is a high likelihood that the person is wearing the same clothing or associated features. Conversely, if a person has changed clothing, this can be a marker that the sub-event has changed. A trip to the beach can soon be followed by a trip to a restaurant during a vacation. For example, the vacation is the super-event and the beach can be where a swimsuit is worn identified as one sub-event, followed by a restaurant outing with a suit and a tie.

The clustering of images into events is further beneficial to consolidate similar lighting, clothing, and other features associated with a person for the creation of a composite model 234 of a person in person profile 236.

Step 212, identification of images having a particular person in the collection, uses person finder 108. Person finder 108 detects persons and provides a count of persons in each photograph in an acquired collection of event images to the event manager 36 using such methods as described in commonly assigned U.S. Pat. No. 6,697,502 to Luo, the disclosure of which is herein included as reference.

In accordance with the present invention, a face detection algorithm followed by a valley algorithm follows a skin detection algorithm. Skin detection utilizes color image segmentation and a pre-determined skin distribution in a preferred color space metric, Lst. (Lee, “Color image quantization based on physics and psychophysics,” Journal of Society of Photographic Science and Technology of Japan, Vol. 59, No. 1, pp. 212-225, 1996). The skin regions can be obtained by classification of the average color of a segmented region. A probability value can also be retained in case a subsequent human figure-constructing step needs a probability instead of a binary decision. The skin detection method is based on human skin color distributions in the luminance and chrominance components. In summary, a color image of RGB pixel values is converted to the preferred Lst metric. Then, a 3D histogram is formed and smoothed. Next, peaks in the 3D histogram are located and a bin clustering is performed by assigning a peak to each bin of the histogram. Each pixel is classified based on the bin that corresponds to the color of the pixel. Based on the average color (Lst) values of human skin and the average color of a connected region, a skin probability is calculated and a skin region is declared if the probability is greater than a pre-determined threshold.

Face detector 270 identifies potential faces based on detection of major facial features using local feature detector 240 (eyes, eyebrows, nose, and mouth) within the candidate skin regions. The flesh map output by the skin detection step combines with other face-related heuristics to output a belief in the location of faces in an image. Each region in an image that is identified as a skin region is fitted with an ellipse wherein the major and minor axes of the ellipse are calculated as also the number of pixels in the region outside of the ellipse and the number of pixels in the ellipse that are not part of the region. The aspect ratio is computed as a ratio of the major axis to the minor axis. The probability of a face is a function of the aspect ratio of the fitted ellipse, the area of the region outside the ellipse, and the area of the ellipse not part of the region. Again, the probability value can be retained or simply compared to a pre-determined threshold to generate a binary decision as to whether a particular region is a face or not. In addition, texture in the candidate face region can be used to further characterize the likelihood of a face. Valley detection is used to identify valleys, where facial features (eyes, nostrils, eyebrows, and mouth) often reside. This process is necessary for separating non-face skin regions from face regions.

Other methods for detecting human faces are well known in the art of digital image processing. For example, a face detection method for finding human faces using a cascade of boosted classifiers based on integral images is described by Jones and Viola in “Fast Multi-View Face Detection”, IEEE CVPR, 2003.

Additional face localizing algorithms use well known methods such as described by Yuille et al. in, “Feature Extraction from Faces Using Deformable Templates,” Int. Journal of Comp. Vis., Vol. 8, Iss. 2, 1992, pp. 99-111. The authors describe a method of using energy minimization with template matching for locating the mouth, eye and iris/sclera boundary. Facial features can also be found using active appearance models as described by T. F. Cootes and C. J. Taylor “Constrained active appearance models”, 8th International Conference on Computer Vision, volume 1, pages 748-754. IEEE Computer Society Press, July 2001. In a preferred embodiment, the method of locating facial feature points based on an active shape model of human faces described in “An automatic facial feature finding system for portrait images”, by Bolin and Chen in the Proceedings of IS&T PICS conference, 2002 is used.

The local features are quantitative descriptions of a person. Preferably, the person finder 108 feature extractor 106 outputs one set of local features and one set of global features 246 for each detected person. Preferably the local features are based on the locations of 82 feature points associated with specific facial features, found using a method similar to the aforementioned active appearance model of Cootes et al.

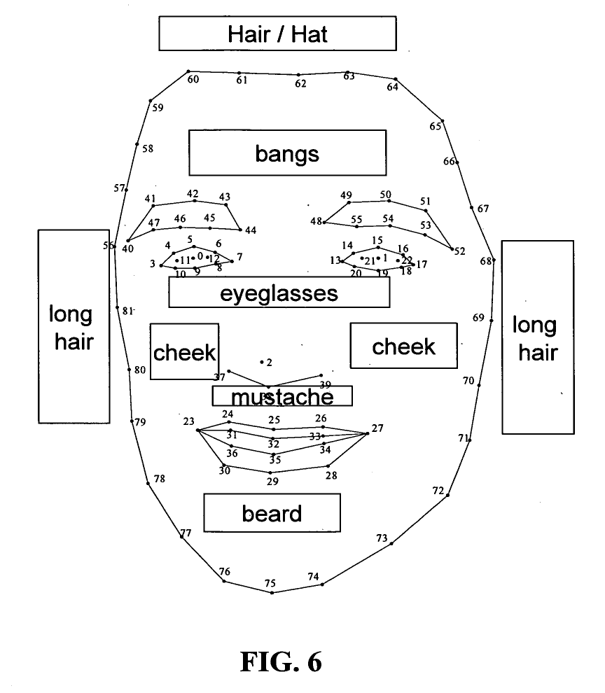

A visual representation of the local feature points for an image of a face is shown in FIG. 6 as an illustration. The local features can also be distances between specific feature points or angles formed by lines connecting sets of specific feature points, or coefficients of projecting the feature points onto principal components that describe the variability in facial appearance.

The features used are listed in Table 1 and their computations refer to the points on the face shown numbered in FIG. 6. Arc (Pn, Pm) is defined as

$${\sum }_{i = n}^{m - 1} ‖ Pn - P ( n + 1 ) ‖$$

where ∥Pn−Pm∥ refers to the Euclidean distance between feature points n and m. These arc-length features are divided by the inter-ocular distance to normalize across different face sizes. Point PC is the point located at the centroid of points 0 and 1 (i.e. the point exactly between the eyes). The facial measurements used here are derived from anthropometric measurements of human faces that have been shown to be relevant for judging gender, age, attractiveness and ethnicity (ref. “Anthropometry of the Head and Face” by Farkas (Ed.), 2^{nd} edition, Raven Press, New York, 1994).

TABLE 1
List of Ratio Features

| Name | Numerator | Denominator |
|---|---|---|
| Eye-to-nose/Eye-to-mouth | PC-P2 | PC-P32 |
| Eye-to-mouth/Eye-to-chin | PC-P32 | PC-P75 |
| Head-to-chin/Eye-to-mouth | P62-P75 | PC-P32 |
| Head-to-eye/Eye-to-chin | P62-PC | PC-P75 |
| Head-to-eye/Eye-to-mouth | P62-PC | PC-P32 |
| Nose-to-chin/Eye-to-chin | P38-P75 | PC-P75 |
| Mouth-to-chin/Eye-to-chin | P35-P75 | PC-P75 |
| Head-to-nose/Nose-to-chin | P62-P2 | P2-P75 |
| Mouth-to-chin/Nose-to-chin | P35-P75 | P2-P75 |
| Jaw width/Face width | P78-P72 | P56-P68 |
| Eye-spacing/Nose width | P07-P13 | P37-P39 |
| Mouth-to-chin/Jaw width | P35-P75 | P78-P72 |

TABLE 2
List of Arc Length Features

| Name | Computation |
|---|---|
| Mandibular arc | Arc (P69, P81) |
| Supra-orbital arc | (P56 − P40) + Int (P40, P44) + |
| | (P44 − P48) + Arc (P48, P52) + (P52 − P68) |
| Upper-lip arc | Arc (P23, P27) |
| Lower-lip arc | Arc (P27, P30) + (P30 − P23) |

Color cues are easily extracted from the digital image or video once the person's facial features are located by the person finder 106.

Alternatively, different local features can also be used. For example, an embodiment can be based upon the facial similarity metric described by M. Turk and A. Pentland. In “Eigenfaces for Recognition”. Journal of Cognitive Neuroscience. Vol 3, No. 1. 71-86, 1991. Facial descriptors are obtained by projecting the image of a face onto a set of principal component functions that describe the variability of facial appearance. The similarity between any two faces is measured by computing the Euclidean distance of the features obtained by projecting each face onto the same set of functions.

The local features could include a combination of several disparate feature types such as Eigenfaces, facial measurements, color/texture information, wavelet features etc. Alternatively, the local features can additionally be represented with quantifiable descriptors such as eye color, skin color, hair color/texture, and face shape.

In some cases, a person's face can not be visible as they have their back to the camera. However, when a clothing region is matched, detection and analysis of hair can be used on the area above the matched region to provide additional cues for person counting as well as the identity of the person present in the image. Yacoob and David describe a method for detecting and measuring hair appearance for comparing different people in “Detection and Analysis of Hair” in IEEE Trans. on PAMI, July 2006. Their method produces a multidimensional representation of hair appearance that include hair color, texture, volume, length, symmetry, hair-split location, area covered by hair and hairlines.

For processing videos, face-tracking technology is used to find the position of a person across frames of the video. Another method of face tracking in video, is described in U.S. Pat. No. 6,700,999, where motion analysis is used to track faces.

Furthermore, in some images, there are limitations to the amount of people these algorithms are able to identify. The limitations are generally due to the limited resolution of the people in the pictures. In situations like this, the event manager 36 can evaluate the neighboring images for the number of people who are important to the event or jump to a mode where the count is input manually.

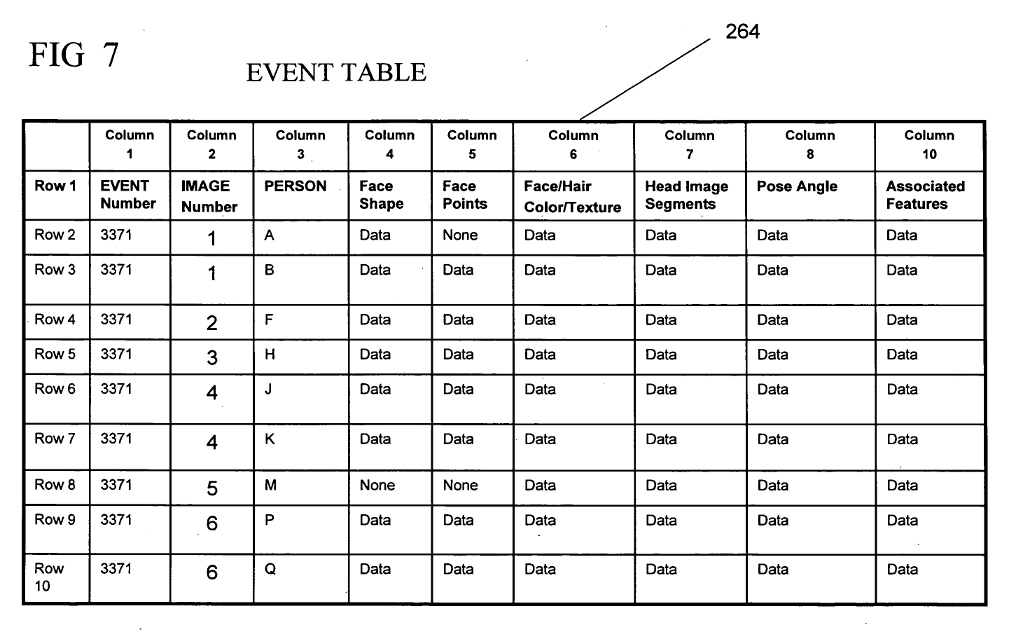

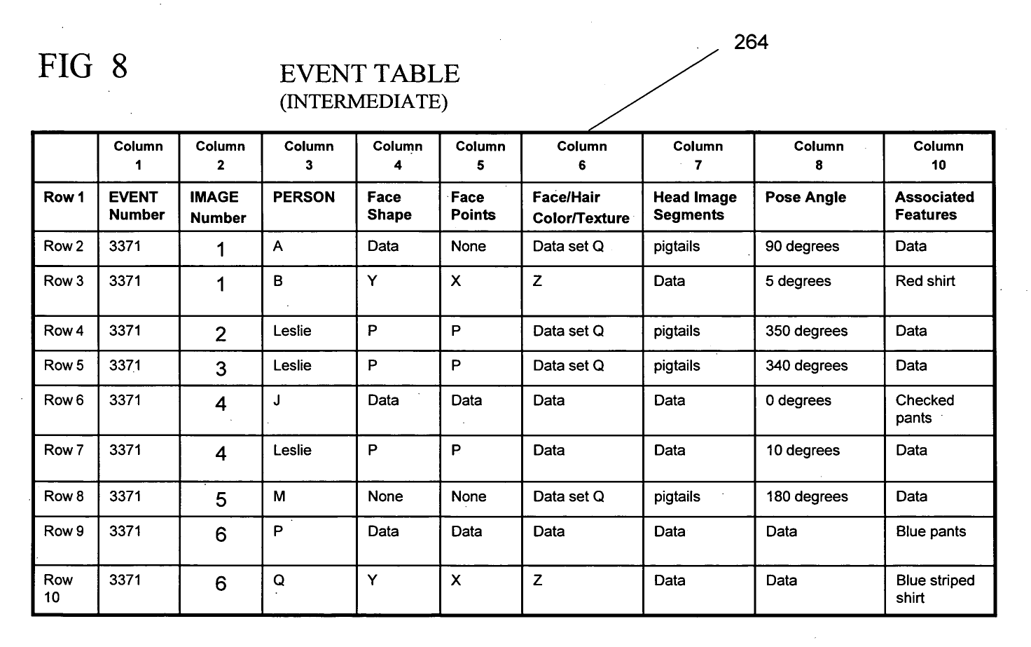

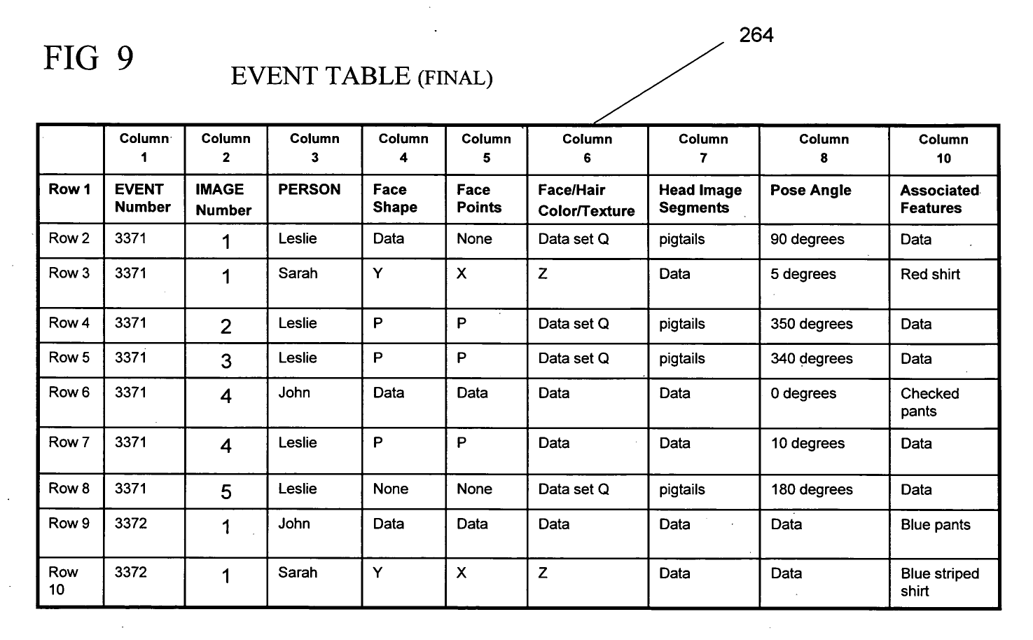

Once a count of the number of relevant persons in each image in FIG. 5 is established, event manager 36 builds an event table 264 shown in FIG. 7, FIG. 8, and FIG. 9 incorporating relevant data to the event. Such data can comprise number of images, and number of persons per image. Additionally, head, head pose, face, hair, and associated features of each person within each image can be determined without knowing who the person is. In FIG. 7, building on previous event data shown in personal profile 236 in FIG. 4, the event number is assigned to be 3371.

If an image contains a person that the database 114 has no record of, the interactive person identifier 250 displays the identified face with a circle around it in the image. Thus, a user can label the face with the name and any other types of data as described in aforementioned U.S. Pat. No. 5,652,880. Note that the terms “tag”, “caption”, and “annotation” are used synonymously with the term “label.” However, if the person has appeared in previous images, data associated with the person can be retrieved for matching using any of the previously identified person classifier 244 algorithms using the personal profile 236 database 114 like the one in shown in FIG. 4, row 1, wherein the data is segmented into categories. Such recorded distinctions are person identity, event number, image number, face shape, face points, Face/Hair Color/Texture, head image segments, pose angle, 3D models and associated features. Each previously identified person in the collection has a linkage to the head data and associated features detected in earlier images. Furthermore, produced composite model(s) 234 of clusters of images are also stored in conjunction with the name and associated event identifier. Using this data, person classifier 244 identifies image(s) having a particular person in the collection. Returning to FIG. 5, Image 1, the left person is not recognizable using the 82 point face model or an Eigenface model. The second person has 82 identifiable points and an Eigenface structure, yet there is no matching data for this person in person profile 236 shown in FIG. 4. In image 2, the person does fit a connection to a face model as data set “P” belonging to Leslie. Image 3 and the right person in image 4 also match face model set “P” for Leslie. An intermediate representation of this event data is shown in FIG. 8.

In step 214, one or more unique features in the identified image(s) associated with the particular person are identified. Associated features are the presence of any object associated with a person that can make them unique. Such associated features include eyeglasses, description of apparel etc. For example, Wiskott describes a method for detecting the presence of eyeglasses on a face in “Phantom Faces for Face Analysis”, Pattern Recognition, Vol. 30, No. 6, pp. 837-846, 1997. The associated features contain information related to the presence and shape of glasses.

Briefly stated, person classifier 244 can measure the similarity between sets of features associated with two or more persons to determine the similarity of the persons, and thereby the likelihood that the persons are the same. Measuring the similarity of sets of features is accomplished by measuring the similarity of subsets of the features. For example, when the associated features describe clothing, the following method is used to compare two sets of features. If the difference in image capture time is small (i.e. less than a few hours) and if the quantitative description of the clothing is similar in each of the two sets of features is similar, then the likelihood of the two sets of local features belonging to the same person is increased. If, additionally, the apparel has a very unique or distinctive pattern (e.g. a shirt of large green, red, and blue patches) for both sets of local features, then the likelihood is even greater that the associated people are the same individual.

Apparel can be represented in different ways. The color and texture representations and similarities described in U.S. Pat. No. 6,480,840 to Zhu and Mehrotra can be used. In another representation, Zhu and Mehrotra describe a method specifically intended for representing and matching patterns such as those found in textiles in U.S. Pat. No. 6,584,465. This method is color invariant and uses histograms of edge directions as features. Alternatively, features derived from the edge maps or Fourier transform coefficients of the apparel patch images can be used as features for matching. Before computing edge-based or Fourier-based features, the patches are normalized to the same size to make the frequency of edges invariant to distance of the subject from the camera/zoom. A multiplicative factor is computed which transforms the inter-ocular distance of a detected face to a standard inter-ocular distance. Since the patch size is computed from the inter-ocular distance, the apparel patch is then sub-sampled or expanded by this factor to correspond to the standard-sized face.

A uniqueness measure is computed for each apparel pattern that determines the contribution of a match or mismatch to the overall match score for persons. The uniqueness is computed as the sum of uniqueness of the pattern and the uniqueness of the color. The uniqueness of the pattern is proportional to the number of Fourier coefficients above a threshold in the Fourier transform of the patch. For example, a plain patch and a patch with single equally spaced stripes have 1 (dc only) and 2 coefficients respectively, and thus have low uniqueness score. The more complex the pattern, the higher the number of coefficients that will be needed to describe it, and the higher its uniqueness score. The uniqueness of color is measured by learning, from a large database of images of people, the likelihood that a particular color occurs in clothing. For example, the likelihood of a person wearing a white shirt is much greater than the likelihood of a person wearing an orange and green shirt. Alternatively, in the absence of reliable likelihood statistics, the color uniqueness is based on its saturation, since saturated colors are both rarer and also can be matched with less ambiguity. In this manner, apparel similarity or dissimilarity, as well as the uniqueness of the apparel, taken with the capture time of the images are important features for the person classifier 244 to recognize a person of interest. Associated feature uniqueness is measured by learning, from a large database of images of people, the likelihood that particular clothing appears. For example, the likelihood of a person wearing a white shirt is much greater than the likelihood of a person wearing an orange and green plaid shirt. In this manner, apparel similarity or dissimilarity, as well as the uniqueness of the apparel, taken with the capture time of the images are important features for the person classifier 244 to recognize a person of interest.

When one or more associated features are assigned to a person, additional verification steps can be necessary to determine uniqueness. It is possible that all of the kids are wearing soccer uniforms, so that in this case, are only distinguished by the numbers and faces as well as glasses or perhaps shoes and socks. Once the uniqueness is identified, these features are stored as unique. One embodiment is to look around the person's face starting with the center of the face in a head-on view. Moles can be attached to cheeks. Jewelry can be attached to ears, tattoos or make-up and glasses can be associated with the eyes, forehead or face, hats can be above or around the head, scarves, shirts swimsuits or coats can be around and below the head etc. Additional tests can be the following:
a) Two people within the same image contain the same associated features but have different features (thus ruling out a mirror image of the same person, as well as the usage of these same associated features as unique features.)
b) At least two positive matches for different faces of at least two persons in all images that contain the same associated feature (thus ruling out these associated features as unique features.)
c) A positive match for the same person in different images but with substantially different apparel. (This is a signal that a new outfit is worn by the person, signaling a different event or sub-event that can be recorded and corrected by the event manager 36 in conjunction with the person profile 236 in database 114.)

In the example of the images shown in FIG. 5, and recorded in FIG. 8, column 7, pigtails are identified as a unique associated feature with Leslie.

Step 216 is searching the remaining images using identified features to identify particular images of a particular person. With each of the positive views of a person, unique features can be extracted from the image file(s) and compared in remaining images. A pair of glasses can be evident in a front and side view. Hair, hat, shirt or coat can be visible in all views.

Objects associated with a particular person can be matched in various ways depending on the type of object. For objects that contain a number of parts or segments (for example, bicycles, cars), Zhang and Chang describe a model called Random Attributed Relational Graph (RARG) in the Proc. of IEEE CVPR 2006. In this method, probability density functions of the random variables are used to capture statistics of the part appearances and part relations, generating a graph with a variable number of nodes representing object parts. The graph is used to represent and match objects in different scenes.

Methods used for objects without specific parts and shapes (for example, apparel) include low-level object features such as color, texture or edge-based information that can be used for matching. In particular, Lowe describes scale-invariant features (SIFT) in International Journal of Computer Vision, Vol. 60, No 2, 2004 that represent interesting edges and corners in any image. Lowe also describes methods for using SIFT to match patterns even when other parts of the image change and there is change in scale and orientation of the pattern. This method can be used to match distinctive patterns in clothing, hats, tattoos and jewelry.

SIFT methods can also have use for local features. In “Person-Specific SIFT features for Face Recognition” by Luo et al. published in the “Proceedings of the IEEE International Conf. on acoustics, speech and Signal Processing (ICASSP), Honolulu, Hi., Apr. 15-20, 2007”. The authors use the person-specific SIFT features and a simple non-statistical matching strategy combined with local and global similarity on key-points clusters to solve face recognition problems.

There are also additional methods dedicated to finding specific commonly occurring objects such as eyeglasses. Wu et al. describe a method for automatically detecting and localizing eyeglasses in IEEE Transactions on PAMI, Vol. 26, No. 3, 2004. Their work uses a Markov-chain Monte Carlo method to locate key points on the eyeglasses frame. Once eyeglasses have been detected, their shape can be characterized and matched across images using the method described by Berg et al. in IEEE CVPR 2005. This algorithm finds correspondences between key points on the object by setting it up as the solution to an integer quadratic programming problem.

Referring back to the collection of event images in FIG. 5 as described in FIG. 8, using color and texture mapping to segment and extract image shapes, pigtails can provide a positive match for Leslie in images 1 and 5. Moreover, Data set Q, associated with Leslie's hair color and texture as well as the clothing color and patterns can provide confirmation of the lateral assignment across images of associated features to the particular person.

Upon the detection of these types of unique associated features, the person classifier 244 labels the particular person the identity earlier labeled, in this example, Leslie.

Step 218 is to segment and then extract head elements and features from identified images containing the particular person. In this case, elements associated with the body and head are segmented and extracted using techniques described in an adaptive Bayesian color segmentation algorithm (Luo et al., “Towards physics-based segmentation of photographic color images,”Proceedings of the IEEE International Conference on Image Processing, 1997). This algorithm is used to generate a tractable number of physically coherent regions of arbitrary shape. Although this segmentation method is preferred, it will be appreciated that a person of ordinary skill in the art can use a different segmentation method to obtain object regions of arbitrary shape without departing from the scope of the present invention. Segmentation of arbitrarily shaped regions provides the advantages of: (1) accurate measure of the size, shape, location of and spatial relationship among objects; (2) accurate measure of the color and texture of objects; and (3) accurate classification of key subject matters.

First, an initial segmentation of the image into regions is obtained. The segmentation is accomplished by compiling a color histogram of the image and then partitioning the histogram into a plurality of clusters that correspond to distinctive, prominent colors in the image. Each pixel of the image is classified to the closest cluster in the color space according to a preferred physics-based color distance metric with respect to the mean values of the color clusters as described in (Luo et al., “Towards physics-based segmentation of photographic color images,” Proceedings of the IEEE International Conference on Image Processing, 1997). This classification process results in an initial segmentation of the image. A neighborhood window is placed at each pixel in order to determined what neighborhood pixels are used to compute the local color histogram for this pixel. The window size is initially set at the size of the entire image, so that the local color histogram is the same as the one for the entire image and does not need to be recomputed.

Next, an iterative procedure is performed between two alternating processes: re-computing the local mean values of each color class based on the current segmentation, and re-classifying the pixels according to the updated local mean values of color classes. This iterative procedure is performed until a convergence is reached. During this iterative procedure, the strength of the spatial constraints can be adjusted in a gradual matter (for example, the value of β, which indicates the strength of the spatial constraints, is increased linearly with each iteration). After the convergence is reached for a particular window size, the window used to estimate the local mean values for color classes is reduced by half in size. The iterative procedure is repeated for the reduced window size to allow more accurate estimation of the local mean values for color classes. This mechanism introduces spatial adaptively into the segmentation process. Finally, segmentation of the image is obtained when the iterative procedure reaches convergence for the minimum window size.

The above described segmentation algorithm can be extended to perform texture segmentation. Instead of using color values as the input to the segmentation, texture features are used to perform texture segmentation using the same framework. An example type of texture features is wavelet features (R. Porter and N. Canagaraj ah, “A robust automatic clustering scheme for image segmentation using wavelets,” IEEE Transaction on Image Processing, vol. Ã5, pp. Ã662-665, April 1996).

Furthermore, to perform image segmentation based jointly on color and texture feature, a combined input composed of color values and wavelet features can be used as the input to the methods described. The result of joint color and texture segmentation is segmented regions of homogeneous color or texture.

Thus, the image segments are extracted from the head and body along with individual associated features and filed by name in personal profile 236.

Step 220 is the construction of a composite model of at least a portion of a person's head using identified elements and extracted features and image segments. A composite model 234 is a subset of person profile 236 information associated with an image collection. The composite model 234 can further be defined as a conceptual whole made up of complicated and related parts containing at least various views extracted of a person's head and body. The composite model 234 can further include features derived from and associated with a particular person. Such features can include defining features such as apparel, eyewear, jewelry, ear attachments (hearing aids, phone accessories), tattoos, make-up, facial hair, facial defects such as moles, scars, as well as prosthetic limbs and bandages. Apparel is generally defined as the clothing one is wearing. Apparel can comprise shirts, pants, dresses, skirts, shoes, socks, hosiery, swimsuits, coats, capes, scarves, gloves, hats and uniforms. This color and texture feature is typically associated with an article of apparel. The combination of color and texture is typically referred to as a swatch. Assigning this swatch feature to an iconic or graphical representation of a generic piece of apparel can lead to the visualization of such an article of clothing as if it belonged to the wardrobe of the identified person. Creating a catalog or library of articles of clothing can lead to a determination of preference of color for the identified person. Such preferences can be used to produce or enhance a person profile 236 of a person that can further be used to offer similar or complementary items for purchase by the identified and profiled person.

Hats can be a random head covering or they can be specific to a particular activity such as baseball. Helmets are another form of hat and can indicate the affiliation of the person with a particular sport. In the case of most sports, team logos are imprinted on the hat. Recognition of these logos, is taught in commonly-assigned U.S. Pat. No. 6,958,821, the disclosure of which is herein incorporated by reference. Using these techniques, can enhance a person profile 236 and use that profile to offer the person additional goods or services associated with their preferred sport or their preferred team. Necklaces also can have characteristic patterns associated with a style or culture further enhancing a profile of a user. They can reflect personal taste with respect to color or style or any number of other preferences.

In Step 222, person identification is continued using interactive person identifier 250 and person classifier 244 until all of the faces of identifiable people are classified in the collection of images taken at an event. If John and Jerome are brothers, the facial similarity can require additional analysis for person identification. In the family photo domain, the face recognition problem entails finding the right class (person) for a given face among a small (typically in the 10s) number of choices. This multi-class face recognition problem can be solved by using the pair-wise classification paradigm; where two-class classifiers are designed for each pair of classes. The advantage of using the pair-wise approach is that actual differences between two persons are explored independently of other people in the data-set, making it possible to find features and feature weights that are most discriminating for a specific pair of individuals. In the family photo domain, there are often resemblances between people in the database, making this approach more appropriate. The small number of main characters in the database also makes it possible to use this approach. This approach has been shown by Guo et al. (IEEE ICCV 2001) to improve face recognition performance over standard approaches that use the same feature set for all faces. Another observation noted by them is that the number of features required to obtain the same level of performance is much smaller when using the pair-wise approach than when a global feature set is used. Some face pairs can be completely separated using only one feature, and most require less than 10% of the total feature set. This is to be expected, since the features used are targeted to the main differences between specific individuals. The benefit of a composite model 234 is that it enables a wide variety of facial features for analysis. In addition, trends can be spotted by adaptive systems for unique features as they appear. In addition, hair may be of two modes, one color and then another, one set of facial hair then another. Typically, these trends are limited to a multimodal distribution. These few modes are able to be supported in a composite model of images that are clustered into events.

With N main individuals in a database, N(N−1)/2 two-class classifiers are needed. For each pair, the classifier uses a weighted set of features from the whole feature set that provides the maximum discrimination for that particular pair. This permits a different set of features to be used for different pairs of people. This strategy is different from traditional approaches that use a single feature space for all face comparisons. It is likely that the human visual system also employs different features to distinguish between different pairs, as reported in character discrimination experiments. This becomes more apparent when a person is trying to distinguish between very similar-looking people, twins for example. A specific feature can be used to distinguish between the twins, which differs from the feature(s) used to distinguish between a different pair. When a query face image arrives, it passes through the N(N−1)/2 classifiers. For each classifier Φ_{m,n}, the output is 1 if the query is categorized as class m, and 0 if categorized as class n. The outputs of the pair-wise classifiers can be combined in several ways. The simplest method is to assign the query face to the class which garners the maximum vote among the N(N−1)/2 classifiers. This only requires computing the vote,

$${\sum }_{i} {Φ}_{m , i} ,$$

for each class m and assigning the query to the class with maximum vote. It is assumed that Φ_{m,n} is the same classifier as Φ_{n,m}.

The set of facial features that are used can be chosen from any of the features typically used for face recognition, including Eigenfaces, Fisherfaces, facial measurements, Gabor wavelets and others (Zhao et al have a comprehensive survey of face recognition techniques in ACM Computing Surveys, December 2003.) There are also many types of classifiers that can be used for the pair-wise, two-class classification problem. “Boosting” is a method of combining a collection of weak classifiers to form a stronger classifier. This is a preferred method in this invention since large margin classifiers, such as AdaBoost (described by Freund and Schapire in Eurocolt 1995), find a decision strategy that provides the best separation between the two classes of the training data, leading to good generalization capabilities. This classification strategy is particularly appropriate in our application, since it is not possible to get a large set of labeled training examples that result in requiring extensive manual labeling from the consumer.

In the example, John has a match for face points and Eigenfaces, and the person classifier names the person John. The uncertain person with face shape y, face points x and face hair color and texture z is identified as Sarah by the user using interactive person identifier 250. Alternatively, Sarah may be identified using data from a different database located on another computer, camera, internet server or removable memory using person classifier 244.

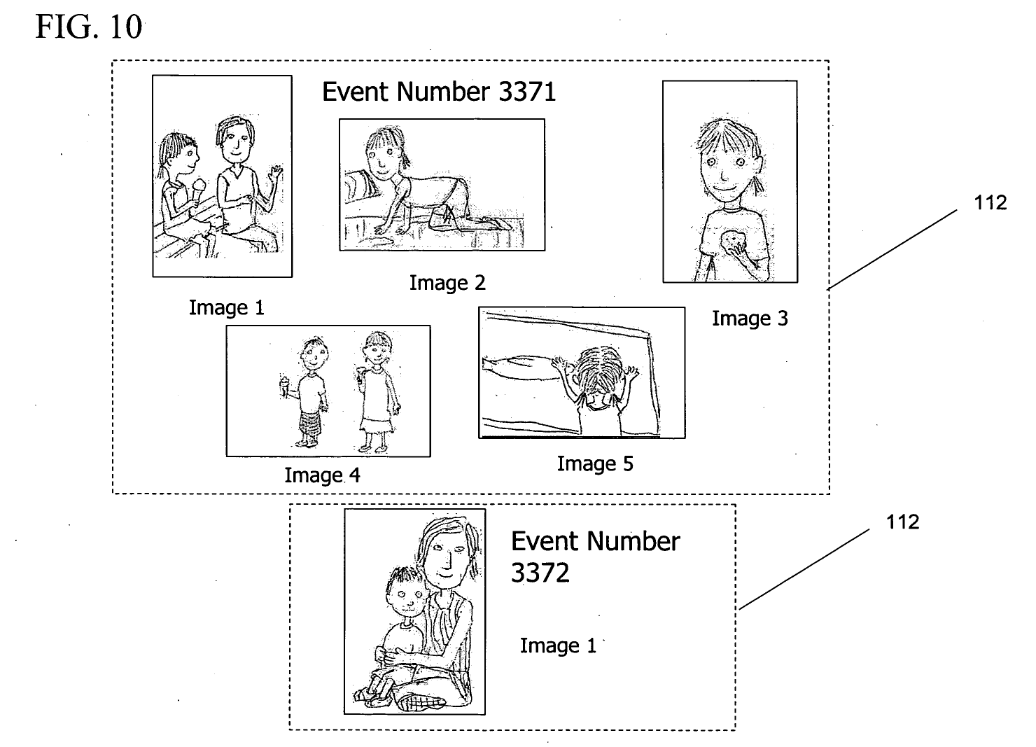

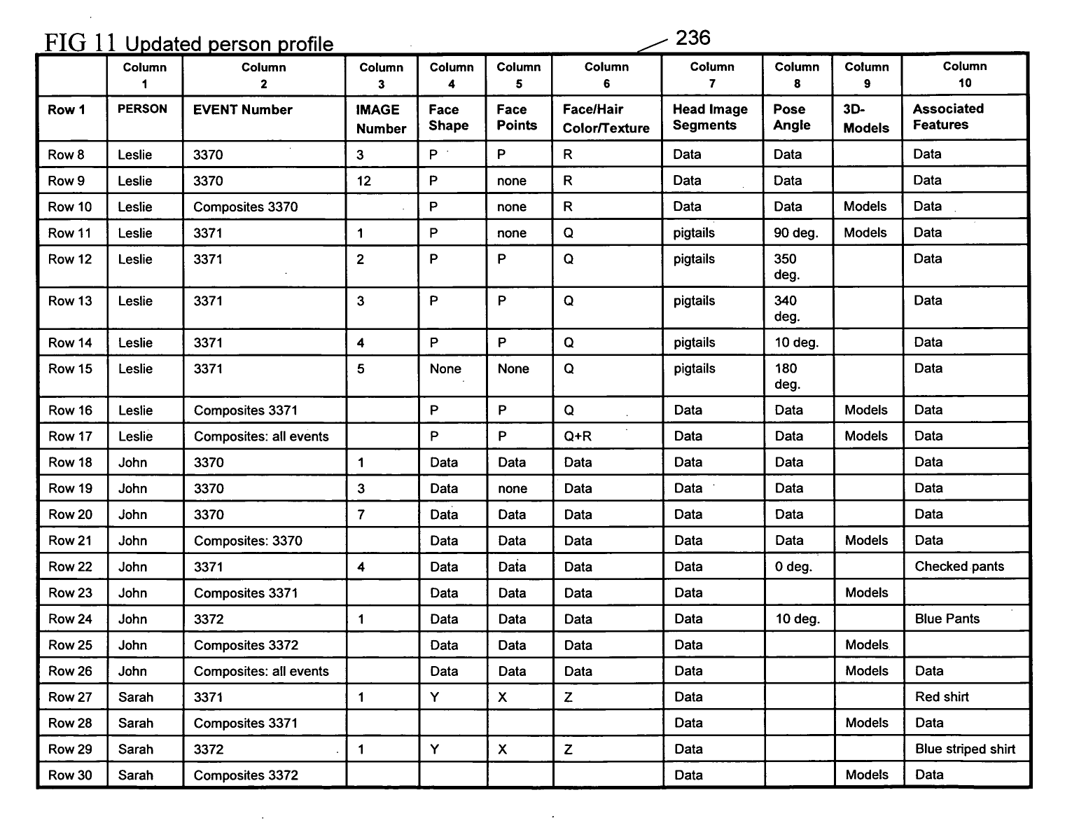

In the example of images from an event in FIG. 5, new clothes are associated with Sarah and new pants are associated with John. This is a marker that the event may have changed. To further refine the classification of images into events, event manager 36 modifies the event table 264 shown in FIG. 9 to produce a new event number, 3372. As a result, event table 264 in FIG. 9 now is complete with person identification and an updated cluster of images is shown in FIG. 10. Data in FIG. 9 can be added to FIG. 4 resulting in an updated person profile 236 as shown in FIG. 11. Note that in FIG. 11, column 6, in Rows 8-16, the data set has changed for Face/Hair Color/Texture for Leslie. It is possible that the hair has changed color from one event to the next, with this data incorporated into a person profile 236.

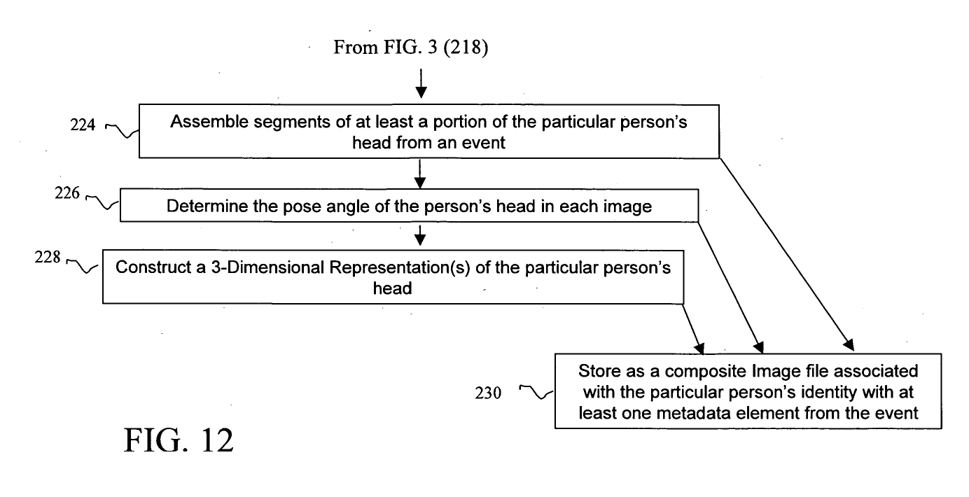

The composite model includes: stored portions of the head of the particular person for later searching; determining the pose of the head in each of the identified images having the particular person; or creating a three dimensional model of the head of the particular person. Referring to FIG. 12, a flow chart for construction of composite model is set forth Step 224 is to assemble segments of at least a portion of the particular person's head from an event. These segments can be separately used as the composite model and are acquired from the event table 264 or the person profile 236. Step 226 is to determine the pose angle for the person's head in each image. Head pose is an important visual cue that enhances the ability of vision systems to process facial images. This step can be performed before or after persons are identified.

Head pose includes three angular components: yaw, pitch, and roll. Yaw refers to the angle at which a head is turned to the right or left about a vertical axis. Pitch refers to the angle at which a head is pointed up or down about a lateral axis. Roll refers to the angle at which a head is tilted to the right or left about an axis perpendicular to the frontal plane. Yaw and pitch are referred to as out-of-plane rotations because the direction in which the face points changes with respect to the frontal plane. By contrast, roll is referred to as an in-plane rotation because the direction in which the face points does not change with respect to the frontal plane. Commonly-assigned U.S. Patent Application Publication 2005/0105805 describes methods of in plane rotation of objects and is incorporated by reference herein.

Model-based techniques for pose estimation typically reproduce an individual's 3-D head shape from an image and then use a 3-D model to estimate the head's orientation. An exemplary model-based system is disclosed in “Head Pose Determination from One Image Using a Generic Model,” Proceedings IEEE International Conference on Automatic Face and Gesture Recognition, 1998, by Shimizu et al., which is hereby incorporated by reference. In the disclosed system, edge curves (e.g., the contours of eyes, lips, and eyebrows) are first defined for the 3-D model. Next, an input image is searched for curves corresponding to those defined in the model. After establishing a correspondence between the edge curves in the model and the input image, the head pose is estimated by iteratively adjusting the 3-D model through a variety of pose angles and determining the adjustment that exhibits the closest curve fit to the input image. The pose angle that exhibits the closest curve fit is determined to be the pose angle of the input image. Thus, a person profile 236 of composite 3-d models is an important tool for continued pose estimation that enables refined 3-d models and improved person identification.

Appearance-based techniques for pose estimation can estimate head pose by comparing the individual's head to a bank of template images of faces at known orientations. The individual's head is believed to share the same orientation as the template image it most closely resembles. An exemplary system is the one proposed by “Example-based head tracking. Technical Report TR96-34, MERL Cambridge Research, 1996, by S. Hiyogi and W. Freeman.

Other appearance-based techniques can employ Neural Networks or Support Vector Machines or other classification methods to classify the head pose. Examples of such method include: “Robust head pose estimation by machine learning,” Ce Wang; Brandstein, M. Image Processing, 2000. Proceedings. 2000 International Conference on Volume 3, Issue, 2000 Page(s): 210-213 vol. 3. Another such example is: “Multi-View Head Pose Estimation using Neural Networks,” Michael Voit, Kai Nickel, Rainer Stiefelhagen, The 2nd Canadian Conference on Computer and Robot Vision (CRV'05) pp. 347-352.

Step 228 is to construct a three-dimensional representation(s) of the particular person's head. With the head examples of the three persons identified in FIG. 10, there are three disparate views of Leslie to produce a sufficient 3D model. The other persons in the images have some data for model creation, but it will not be as accurate as the one for Leslie. Some of the extracted features could be mirrored and tagged as such for composite model creation. However, the person profile 236 of John will have earlier images that can be used to produce a composite 3D model from earlier events combined with this event.

Three-dimensional representations are beneficial for subsequent searching and person identification. These representations are useful for avatars associated with persons narrating, gaming, and animation. A series of these three-dimensional models can be produced from various views in conjunction with pose estimation data as well as lighting and shadow tools. Camera angle derived from a GPS system can enable consistent lighting, thus improving the 3D model creation. If one is outside, lighting may be similar if the camera is pointed in the same direction relative to the sunlight. Furthermore if the background is the same for several views of the person, as established in the event manager 36, similar lighting can be assumed. It is desired as well, to compile a 3D model from many views of a person in a short period of time. These multiple views can be integrated into 3D models with interchangeable expressions based on several different front views of a person.

3D models can be produced from one or several images with the accuracy increased with the number of images combined with head sizes large enough to provide sufficient resolution. Some methods of 3D modeling are described in commonly assigned U.S. Pat. Nos. 7,123,263; 7,065,242; 6,532,011; 7,218,774 and 7103,211 the disclosures of which are herein incorporated by reference. The present invention makes use of known methods that use an array of mesh polygons or a baseline parametric or generic head model. Texture maps or head feature image portions are applied to the produced surface to generate the model.

Step 230 is to store as a composite image file associated with the particular person's identity with at least one metadata element from the event. This enables a series of composite models over the events in a photo collection. These composite models are useful for grouping appearance of a particular person by age, hairstyle, or clothing. If there are substantial time gaps in the image collection, image portions with similar pose angle can be morphed to fill in the gaps of time. Later, this can aid the identification of a person upon the addition of a photograph from the time gap.

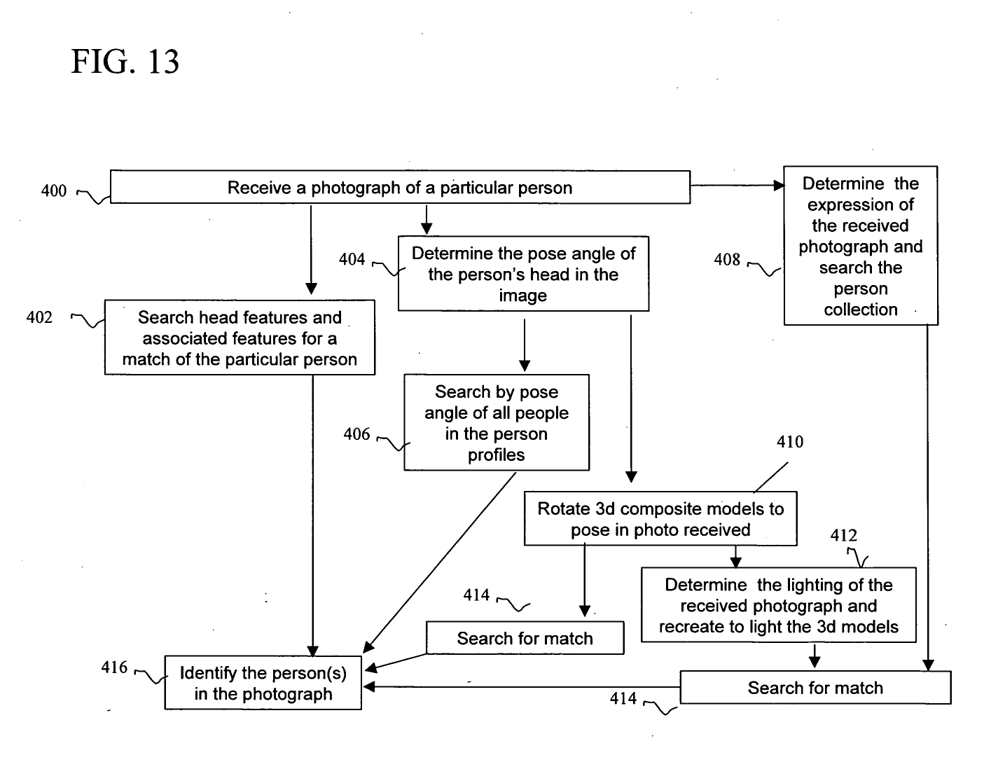

Turning to FIG. 13, a flow chart for the identification of a particular person in a photograph describes the usage of a composite model.

Step 400 is to receive a photograph of a particular person

Step 402 is to search for head features and associated features for a match of the particular person.

Step 404 is to determine the pose angle of the person's head in the image.

Step 406 is to search by pose angle of all people in person profiles.

Step 408 is to determine expression of the receive photograph and search the person database.

Step 410 is to rotate the 3D composite model(s) to the pose in the photo received.

Step 412 is to determine the lighting of the received photograph and reproduce to light the 3D model.

Step 414 is to search the collection for a match.

Step 416 is the identification of the person in the photograph, manual, auto, or propose identifications.

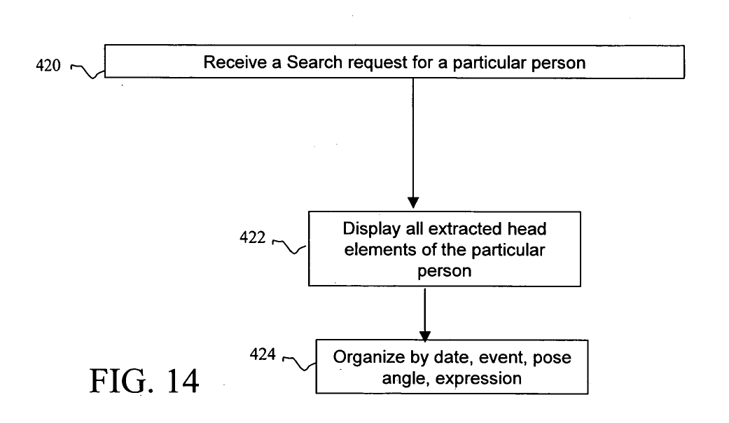

FIG. 14 is a flow chart for the searching of a particular person in a digital image collection for another usage for the composite model.

Step 420 is to receive a search request for a particular person.

Step 422 is to display extracted head elements of the particular person.

Step 424 is to organize the display by date, event, pose, angle, expression etc.

Those skilled in the art will recognize that many variations can be made to the description of the present invention without significantly deviating from the scope of the present invention.

PARTS LIST

| | |
|---|---|
| 36 | event manager |
| 102 | digital image collection |
| 104 | labeler |
| 106 | feature extractor |
| 108 | person finder |
| 110 | person detector |
| 112 | digital image collection subset |
| 114 | database |
| 130 | extraction and segmentation. |
| 210 | block |
| 212 | block |
| 214 | block |
| 216 | block |
| 218 | block |
| 220 | block |
| 222 | block |
| 224 | block |
| 226 | block |
| 228 | block |
| 230 | block |
| 234 | composite model |
| 236 | person profile |
| 238 | associated features detector |
| 240 | local feature detector |
| 242 | global feature detector |
| 244 | person classifier |
| 246 | global features |
| 250 | interactive person identifier |
| 252 | person extractor |
| 254 | person image segmentor |
| 258 | associated features segmentor |
| 260 | pose estimator |
| 262 | 3D model creator |
| 264 | event table |
| 270 | face detector |
| 272 | capture time analyzer |
| 301 | digital camera phone |
| 303 | flash |
| 305 | lens |
| 311 | CMOS image sensor |
| 312 | timing generator |
| 314 | image sensor array |
| 316 | A/D converter circuit |
| 318 | DRAM buffer memory |
| 320 | digital processor |
| 322 | RAM memory |
| 324 | real-time clock |
| 325 | location determiner |
| 328 | firmware memory |
| 330 | image/data memory |
| 332 | color display |
| 334 | user controls |
| 340 | audio codec |
| 342 | microphone |
| 344 | speaker |
| 350 | wireless modem |
| 352 | RF channel |
| 358 | phone network |
| 362 | dock interface |
| 364 | dock/charger |
| 370 | Internet |
| 372 | service provider |
| 375 | general control computer |
| 400 | block |
| 402 | block |
| 404 | block |
| 406 | block |
| 408 | block |
| 410 | block |
| 412 | block |
| 414 | block |
| 416 | block |
| 420 | block |
| 422 | block |
| 424 | block |

1. A method of improving recognition of a particular person in images by constructing a composite model of at least the portion of the head of that particular person, comprising
(a) acquiring a collection of images taken during a particular event;
(b) identifying image(s) having a particular person in the collection;
(c) identifying one or more features in the identified image(s) associated with that particular person;
(d) searching the collection using the identified features to identify the particular person in other images of the collection; and
(e) constructing a composite model of at least a portion of the particular person's head using identified images of the particular person.

2. The method of claim 1 wherein the features include apparel.

3. The method of claim 1 wherein the composite model includes:
(i) stored portions of the head of the particular person for later searching;
(ii) determining the pose of the head in each of the identified images having the particular person; or
(iii) creating a three dimensional model of the head of the particular person;

4. The method of claim 3 further including storing the identified features for use in searching subsequent collections.

5. The method of claim 3 further comprising using the composite model (i) or (iii) to search other image collections to identify the particular person.

6. The method of claim 5 further including using the stored identified features to search other image collections to identify the particular person.

7. The method of claim 3 further comprising using the composite model (ii) and extracting head features and using such extracted head features to search other image collections to identify the particular person.

8. The method of claim 7 further including using the stored identified features to search other image collections to identify the particular person.
